(19) United States
(12) Patent Application Publication
(10) Pub. No.: US 2005/0004823 A1
(43) Pub. Date: Jan. 6, 2005

(54) Systems and methods for complexity management

(76) Inventor: John H. Hnatio, Union Bridge, MD (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/694,024

(22) Filed: Oct. 28, 2003

Related U.S. Application Data
(60) Provisional application No. 60/421,577, filed on Oct. 28, 2002.

(51) Int. Cl. G06F 17/60

(52) U.S. Cl. 705/7; 705/10

(57) ABSTRACT

A method and system for assisting in the prediction, detection, deterrence, prevention and mitigation of potential terrorist attacks. In one embodiment, various scenarios are designed to simulate possible terrorist attacks or other crises. These scenarios are presented to a decision maker operating, for example, under an organizational policy. The scenarios may be presented, for example, in an immersion environment in multimedia format, and the responses of the decision maker are evaluated. The results are then used, for example, to evaluate the effectiveness of the policy, or to evaluate the decision maker for training purposes. The results are also used, for example, in an analogous events library, which a decision maker refers to in an actual crisis.

This application claims priority to applicants' copending U.S. Provisional Application Ser. No. 60/421,577 titled “SYSTEMS AND METHODS FOR COMPLEXITY MANAGEMENT” filed Oct. 28, 2002, the entirety of which is incorporated herein by reference.

### BACKGROUND OF THE INVENTION

1. Field of the Invention

The present invention relates to systems and methods for the mitigation of crises, and in particular, to systems and methods to materially assist in the prediction, detection, deterrence, prevention, and mitigation of potential terrorist attacks.

2. Background of the Technology

As various technologies evolve, human operators are required to deal with increasingly complex systems. Due to this increasing complexity, operators managing facilities, such as nuclear power plants or water supplies, are provided with a relatively large amount of information. Similarly, decision makers whose authority governs resources, such as the nation's agricultural output, institutions, such as the New York Stock Exchange, or a labor force, such as a fire department, are provided with a large amount of information. In the face of a crisis, such as a military, terrorist, agro-terrorist, or cyber attack, an operator or other decision maker is required to analyze this wealth of information and to apply a standard policy to make crucial decisions.

As systems become more complex, decision makers may be provided with so much information that they are unable to comprehend the entire system. Furthermore, the information may be provided in a manner in which it is difficult or impossible to separate crucial information from trivial information. In addition, the standard policies that govern the decisions of the decision makers may be ill suited to particular situations.

In the face of a crisis, such as a terrorist attack, it is crucial for a decision maker to identify important information. It is further necessary for the standard policy to which the decision maker conforms to be as comprehensive as possible. Therefore, there is an unmet need for systems and methods for identifying potential threats and crises in advance, and for determining the appropriate policy to follow when such crises occur. There is a further need for systems and methods that provide appropriate information to decision makers in an appropriate format, to enable, for example, the decision maker to act appropriately in the face of a crisis.

Among other problems with the prior art are the following: 1) complex systems defy human understanding (James Gleick, Chaos: Making a New Science (1988) (“Gleick”); I. Prigogine, et al., Exporing Complexity: An Introduction (1998); and Arthur I. Miller, Insights of Genius: Imagery and Creativity in Science and Art (2000) (“Miller”), each of which is incorporated herein by reference); 2) there is a human inability to respond quickly enough to prevent catastrophic systems failures (C. Perrow, Normal Accidents (1982), (“Perrow”) which is incorporated herein by reference); 3) it is impossible to identify all system redundancies necessary to prevent catastrophes (S. D. Sagan, The Problem with Redundancy Problem: Or Why Organizations Try Harder and Fail More (2001) (“Sagan”), which is incorporated herein by reference); 4) management of complex events and situations becomes more difficult as systems become more “closely coupled” and systems interdependencies multiply (T. Helm, Cerro Granee Fire Decision-Making: Analysis of the Decision Drivers (2001) (“Helm”), which is incorporated herein by reference; Perrow); 5) no effective method exists to integrate the quantitative with the qualitative social process aspects of complex systems (Helm; Perrow); and 6) catastrophes are inevitable (Perrow).

These problems raise several questions, including the following, which remain unresolved in the prior art: 1) is there new knowledge that can enhance our understanding of complex systems?; 2) are there new methods to manage complex systems in ways that we can avoid catastrophes?; and 3) how can these new methods be applied in a practical way?

### SUMMARY OF THE INVENTION

In one embodiment, the present invention relates to a system and method for simulating crises, such as terrorist attacks. Computer models and simulations of social dynamics representing novel events are used to create a decision assessment environment to assist decision makers in the a priori development and testing of different policy options and processes, as hypothetical complex event simulations evolve. Special techniques to develop, visualize, and present scenarios are applied to enhance the believability of these scenarios and to create the types of real world technical and social process challenges that participants would face in the management of a real world crisis.

In some embodiments, decision assessment environments also include models and simulations of events and situations in regional areas of strategic importance to a selected country, such as the United States. Among other things, situation assessment environments in these embodiments allow decision makers to test the effectiveness of different policy options in achieving desired outcomes in hypothetical events and situations before they are confronted in the real world. Special attention is paid to the early phases of events and situations in some embodiments, in order, for example, to identify decision options and alternatives that can prevent and mitigate the harmful outcomes or maximize the possible benefits that can arise from complex events and situations.

An embodiment of the present invention provides a system and method for creating a policy, for training a decision maker, and for creating a format to provide information to a decision maker. One or more scenarios corresponding to crises are developed. These scenarios are science based, analogously derived, and driven by real world databases. For each scenario, critical decision points (CDPs) are identified. The CDPs are moments in the scenario wherein a decision has a comparatively greater potential to affect the outcome of the scenario. In one embodiment, for each CDP, multi-domain experts are gathered. These experts include individuals whose knowledge of one aspect of the CPD is superlative. Using the input of each of the experts, a range of potential decision options for the CPD is determined. Special knowledge acquisition/generation tools are then used to prioritize the importance and extended order effects of decisions. The results are then dynamically archived. Mitigation strategies are developed to address the extended order of effect for each decision.

Using the archived decisions, scenarios are then run, for example, via a device with a processor, such as a personal computer (PC), with one or more human operators acting as the decision maker. In some embodiments, the scenario may be run in a “start-stop-replay” manner, such that the decision maker can witness the results of different decisions. The reactions of the decision maker to various presentations of information are capable of being analyzed. The presentations of information are alterable, based on the reactions of a plurality of decision makers. Alternately or in addition, the presentations of information may be customized to an individual decision maker. Running the scenario is usable to test the effects of various decisions and policies. Running the scenario is also usable to customize, refine, or change the presentation of information. Running the scenario is further usable to train an individual decision maker. After running a scenario, another scenario may be created, or the first scenario may be re-run.

In embodiments of the present invention, an analogous event library is generatable for use in real world contingencies. The analogous event library may contain the results of running one or more scenarios and may be referred to by decision makers in the face of a real-life crisis. By comparing the crisis at hand to a scenario in the analogous event library, and by viewing the results of various decisions present in the analogous event library, a decision maker may gain information as to how various decisions may affect the situation at hand.

In one embodiment of the present invention, using the world's most advanced models and simulations of social dynamics representing novel events, a decision assessment environment is created to assist decision makers in the a priori development and testing of different policy options and processes as hypothetical complex event simulations evolve. Special techniques to develop, visualize, and present scenarios are applied to enhance the “believability” of these scenarios, and to create the types of real world technical and social process challenges that participants would face in the management of a real world crisis. One embodiment of the present invention includes believable decision assessment environments, so that participants feel completely immersed in the process. Examples of hypothetical events and situations that are able to be simulated using these environments include terrorist attacks at home and abroad involving chemical, biological, or nuclear weapons, cyber and other attacks against commercial and financial sectors and other critical infrastructures of a nation and its allies, agro-terrorism, and other complex non-traditional threats to national security.

Decision assessment environments also optionally include models and simulations of events and situations in regional areas of strategic importance to a country. Situation assessment environments allow decision makers to ask the tough “what if” questions and to test the effectiveness of different policy options in achieving desired outcomes in hypothetical events and situations before these decision makers are confronted in the real world. Special attention is paid to the early phases of events and situations in order to identify decision options and alternatives that can prevent and mitigate the harmful outcomes or maximize the possible benefits that can arise from complex events and situations.

In one embodiment, decision assessment scenarios are conducted so that participants can be isolated from their normal job environments and not distracted by their day-to-day work activities. Decision assessment scenarios present hypothetical situations and events that create a complex crisis or problem for participants to address. Participants have access to the entire tool suite (information technology (IT) tools, simulations, and knowledge bases) for information gathering and analysis to guide decision-making. The deliberations and actions of the participants in decision assessment scenarios are documented in detail and digitally archived in a “lessons learned” library. This library is used to provide “real-time” feedback during mock crisis events or situations and post-event analysis. Using the methods and techniques tested as part of a course conducted at National Defense University, special attention is given to benchmarking both the technical and social process knowledge aspects of the performance of participants as they go through decision assessment scenarios.

The present invention also optionally includes use of specially tailored decision support tools to acquire essential information from disparate sources (e.g., geographically dispersed subject matter experts across a range of knowledge domains, using distributed communication techniques). The present invention may also be used in conjunction with knowledge acquisition tools that capture, structure, and archive subject matter knowledge across different domains in ways that can promote the generation of new knowledge. Furthermore, Myers Briggs Typology Indicator (MBTI) and other psychological assessment tools are optionally used to provide a better understanding of the role of human personality and learning preferences in decision making. For example, the decision assessment environments may be tailored to support the unique learning and decision characteristics of individual decision-makers.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 presents a flow diagram of an overview of the process of one embodiment of the present invention;

FIG. 2 shows the five cognitive frames of reference and their polar opposites for use in accordance with one embodiment of the present invention;

FIGS. 3A and 3B contain an epistemological logic block in accordance with an embodiment of the present invention;

FIGS. 4A and 4B show a bipolar instrument utilizing a Lichert scale for use in accordance with embodiments of the present invention;

FIG. 5 illustrates aspects of periodic versus aperiodic systems;

FIG. 6 shows a representative diagram of a state space having periodic and aperiodic regions, with observed and agent-based iterative solutions shown, in accordance with embodiments of the present invention;

FIG. 7 contains a representative diagram of possible event outcomes and mitigation strategies for an example event, in accordance with an embodiment of the present invention;

FIG. 8 shows a representative diagram of various features of a consensus team decision model, in accordance with an embodiment of the present invention;

FIG. 9 shows the various system components used in an embodiment of the present invention;

FIG. 10 presents an example of a computer system usable in conjunction with embodiments of the present invention;

FIG. 11 shows details regarding the process methodology of one embodiment of the present invention; and FIG. 12 is a notional diagram of a decision assessment environment for exploring the validity and integration of policies among different organizations.

### DETAILED DESCRIPTION

A number of complexity challenges face decision makers in complex situations, including the following: 1) complex systems defy human understanding; 2) there is a human inability to respond quickly enough to prevent catastrophic system failures; 3) it is impossible to identify all system redundancies necessary to prevent catastrophes; and 4) management of complex events poses new problems as system interdependencies multiply and become more “closely coupled.” Obstacles to the understanding of complex systems include the fact that reigning epistemological constructs (e.g., positivism, logical positivism and postpositivism) rely on Newtonian frames of reference, namely, linear causality, reductionism, certainty of measurement (Newtonian mechanics), reversibility of systems and inductive empiricism.

In 1982, Charles Perrow published “Normal Accidents,” espousing a new paradigm for thinking about complex systems known as normal accident theory. This work included the following determinations: 1) systems reach levels of complexity where major accidents become inevitable; 2) accidents are the result of our inability to integrate the quantitative technical aspects of complex systems with the qualitative human factors aspects; and 3) the first two factors in combination give rise to Perrow's conclusion that the use/creation of complex systems must be avoided if catastrophic accidents are to be avoided.

Two major questions are posed by these various issues: 1) is there new knowledge that can enhance understanding of complex systems?; and 2) are there new methods that can be employed to manage complex systems in a way to avoid catastrophes?

The present invention addresses these questions by comparing three driving epistemological constructs and seven theories that have shaped modern understanding of the natural world. Based on a review of the scholarly literature a new pattern has emerged, which forms the basis for a new epistemology known as apriori optionality. This new epistemology is based on use of five Newtonian frames and polar opposites thereof: linear causality-non linearity; reductionism-holism; certainty-indeterminacy; reversibility-irreversibility; and induction-deduction. These frames and their opposites are compared and contrasted using epistemological constructs and the seven identified theories, for example. Through this process, the systems and methods of the present invention seek to identify pattern sets that do not match epistemological pattern sets.

This new epistemology considers complex systems as typically being made up of or involving the following factors: 1) these systems contain non-linearity; 2) these systems are best understood holistically by identifying patterns; 3) complex systems are indeterminate; 4) complex systems are irreversible; 5) deduction can be used with these systems to identify patterns; and 6) induction can be sued to discern rule sets driving patterns of behavior relating to these systems. The present invention thus gives rise to a new way of thinking about complex systems and their management, including the following propositions: 1) everything is interdependent and change is continuous; 2) systems exists in three phases—a) aperiodic at a quantum level, b) periodic at a human sense level, and c) aperiodic at a cosmic level; 3) a system should be evaluated holistically—deduction should be used to identify aperiodic eruptions, then aperiodic eruptions analyzed using inductive empirical methods to discern rule sets (Mitchell Resnick, Turtles, Termites and Traffic Jams: Explorations in Massively Parallel Microworlds (1999), which is incorporated herein by reference); 4) non-Newtonian frames should be used as the starting point for thinking about complex systems; and 5) a structured process for applying apriori optionality is suggested.

The process of the system and method of the present invention includes developing scenarios, gathering information relating to identified CDPs, generation and running of scenarios, incorporating special consideration of human factors, and creation of an “analogous event” library. With regard to developing scenarios, typically, these scenarios are science based, analogously derived, driven by real world databases, and identify CDP. As to building CDPs, generally, these functions include gathering multi-domain experts, identifying a range of potential decision options, using special knowledge acquisition/generation tools to prioritize importance and extended order effects of decisions, dynamically archiving results, and developing mitigation strategies to address extended order of effect.

Embodiments of the present invention use continuous generation of scenarios, re-run of scenarios, computer generated options, etc. In addition, special consideration of human factors as integral to process are used, including the following: 1) cognitive assessments to determine decision styles to assure diversity and to “bring the right information, in the right form, at the right time” to the decision maker; 2) analysis of individual preferences for working in teams; 3) assessments to promote new consensus methods; and 4) special data visualization methods based on decision styles. Finally, embodiments of the present invention incorporate creation of one or more “analogous event” libraries for immediate use in real world contingencies.

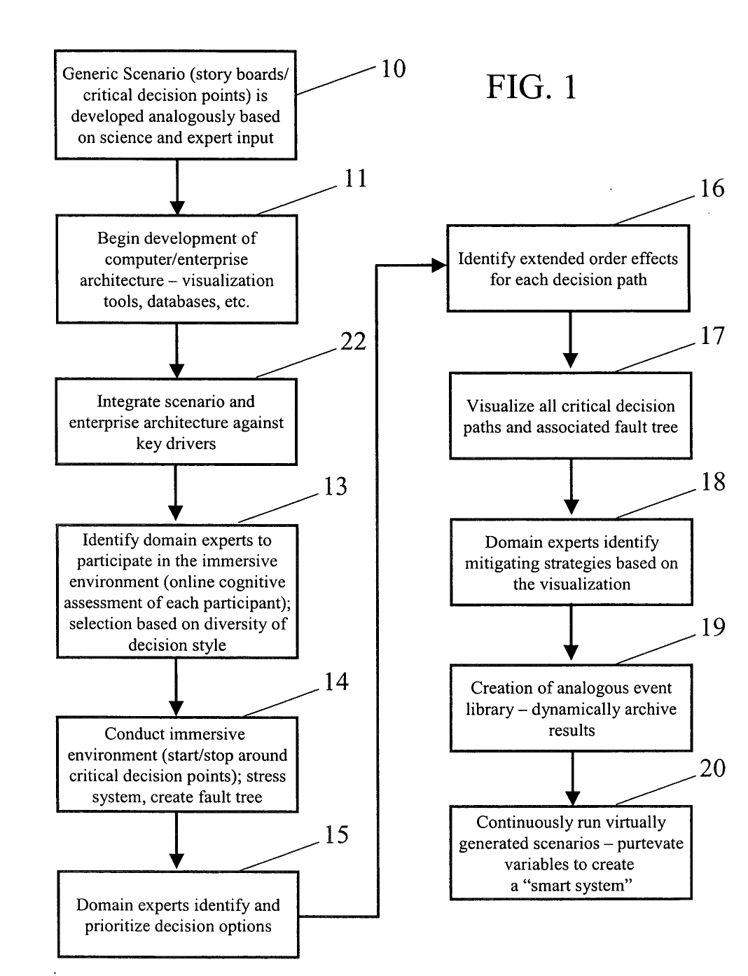

FIG. 1 presents a flow diagram of an overview of the process of one embodiment of the present invention.

The present invention provides a proactive approach to non-traditional threats to national security. One embodiment of the present invention includes a focus on agroterrorism and protection of a nation's food supply, utilizing advanced technology in the application of complexity-management techniques designed to materially assist in the prediction, detection, deterrence, prevention and mitigation of potential terrorist attacks.

Through high-performance modeling and simulation capabilities, data-mining and information analysis, multidisciplinary expertise, and an expanding core of specialized knowledge on human thought processes, problem solving interactions and decision-making, the present invention provides the ability to examine complex interrelationships in ways that reveal unforeseen and unexpected possibilities as well as unanticipated and unintended consequences. Because of these capabilities, the present invention offers a unique laboratory for testing response capabilities and effectiveness against multiple hypothetical scenarios before a real crisis occurs. Of additional importance, the present invention affords opportunity for enhanced predictive, preventive and ameliorative strategies in the face of national security vulnerability across a broad range of fronts.

The concept of the present invention is founded on the belief that the Newtonian principles of linearity and reductionism are no longer sufficient to deal with the new levels of complexity that are reshaping the strategic national security environment. The present invention's approach embraces complexity theory, normal accident theory and the notions of pattern recognition and irreversibility as methods to better understand and manage complex systems and the interactions among systems.

With some embodiments of the present invention, an “immersive decision” architecture is used to bring operational responders, field and area specialists, decision-makers at all levels, and others, from across different knowledge domains and organizational boundaries together to work through real-world threat scenarios. Special decision support systems, including knowledge acquisition and generation tools, consensus team decision models and knowledge bases are used. High performance computer modeling and simulation features enhance the process by integrating, organizing and presenting critical information.

One feature of the present invention is the use of multidisciplinary expertise, intelligence, advanced computational capabilities, as well as a variety of other resources, to identify problems and challenges and to collectively develop “best” solutions before disaster strikes in the real world. The threat event analysis feature of embodiments of the present invention uses immersive decision architecture that cuts across the entire potential event continuum—detection, deterrence, prevention, response, and mitigation. Through the use of this architecture, the present invention is able to facilitate direct encounters with the unexpected and the unintended, such that potential terrorist events can be anticipated and rendered preventable, manageable and unsurprising. One advantage of the present invention is that it supports learning more about what is not known, in ways that may not be imagined, so that real life catastrophes can be avoided. Protecting a nation's communities by providing first responders, as well as all involved decision makers, with what is needed to save lives and prevent harm is an important foundation for building the kind of local, state and national preparedness that is both effective and ultimately successful.

The method and system of the present invention includes use of comparison of three reigning epistemological constructs and seven theories that have shaped scientific understanding of the natural world. The present invention also utilizes five cognitive frames of reference and associated polar opposites to compare and contrast three epistemological constructs and seven applicable scientific theories. Among other things, the present invention seeks to identify scientific pattern sets that do not match three reigning epistemological pattern sets.

In particular, the present invention incorporates consideration of the theories of 1) positivism and logical positivism, and 2) post positivism. Positivism and logical positivism are defined herein as follows:
An objective reality exists independent of the observer. All science rests on a foundation of facts. Once enough facts are collected and analyzed, generalizations can be extracted enabling the scientist to predict, given some set of circumstances at T₁, some fact that will still hold true at T₂. If the prediction is true, then the hypothesis, principle or theory must also be true.
   Post positivism is defined herein as follows:
All that is observed is affected by observation. All observations are fallible making all theory subject to revision. Thus, multiple measures and observations are core to the advancement of knowledge, i.e., triangulation. Constant scrutiny of research and re-observation leads to the evolutionary creation of the “best” knowledge. Hypotheses, principles and theories are subject to constant revision.

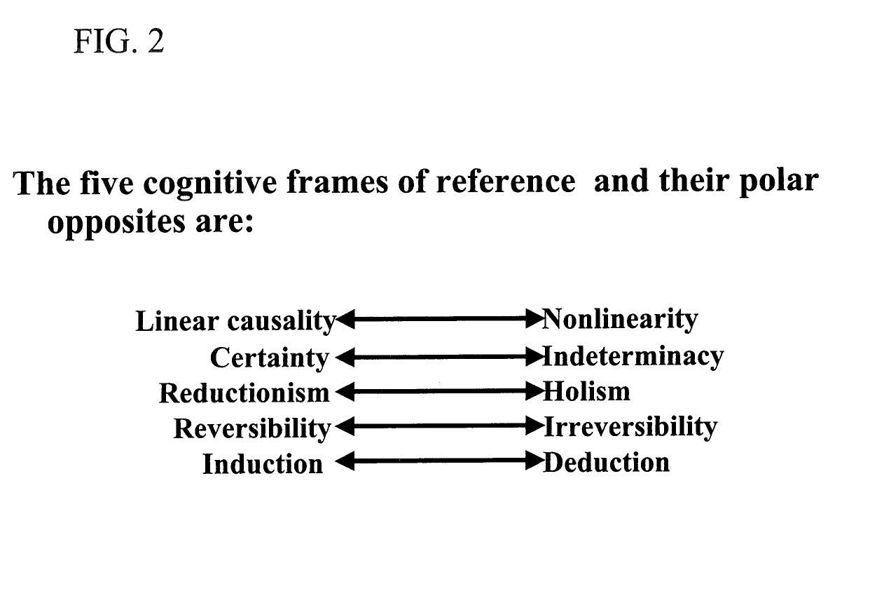

The five cognitive frames of reference and their polar opposites are shown in FIG. 2. The seven scientific theories considered in the present invention include: 1) special and general relativity (Einstein); 2) probability theory (Heisenberg); 3) dissipative structure theory (Prigogine); 4) complexity theory (Gleick); 5) normal accident theory (Perrow); and 6) consilience theory (Wilson).

Study of the scholarly literature indicates that reigning epistemological constructs are strongly influenced by Newtonian cognitive frames of reference. This approach conceives of systems as being periodic. Study of the scholarly literature also indicates that epistemological constructs do not reflect advances in scientific understanding of complex naturally occurring systems. These constructs include complex human social systems.

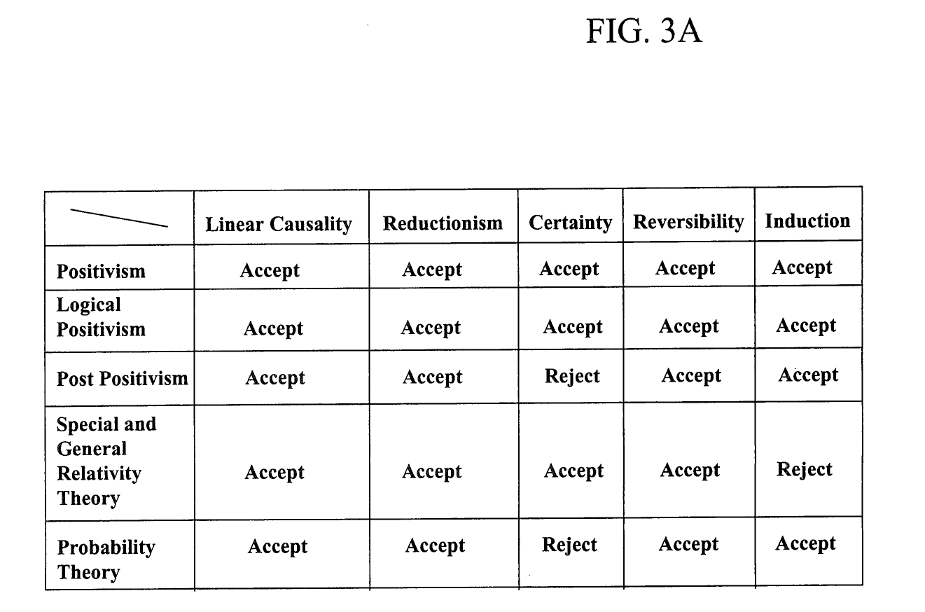

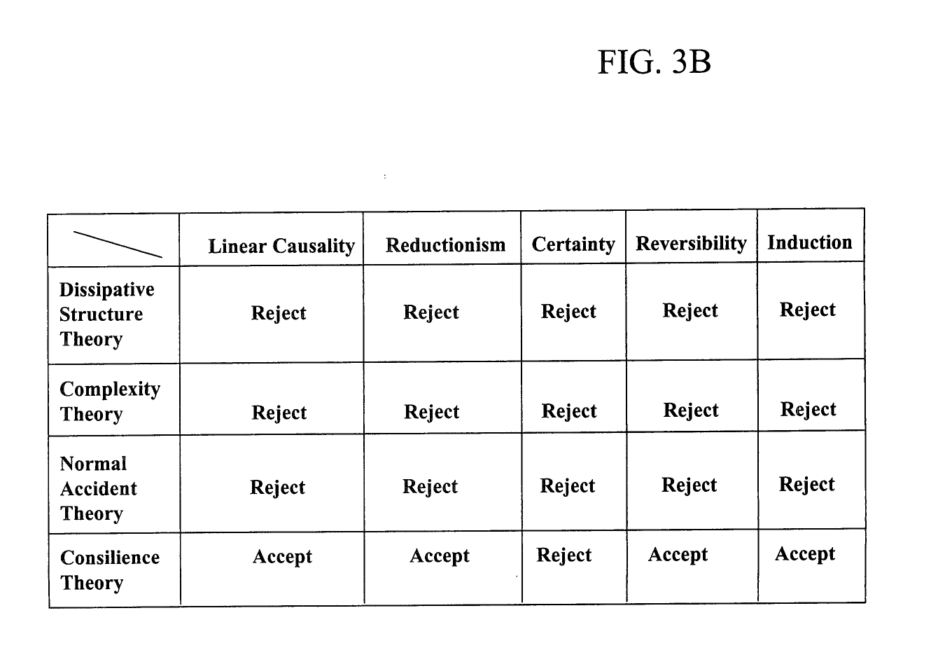

An epistemological logic block in accordance with an embodiment of the present invention appears in FIGS. 3A and 3B. In one implementation of the present invention, the epistemological logic block of FIGS. 3A and 3B is validated by the five renowned knowledge domain experts. In one embodiment, knowledge domain experts are asked to complete a survey questionnaire that asks each expert to validate the degree of “acceptance” or “rejection” of ten conceptual frames of reference as these frames of reference relate to the three epistemologies and each of the seven scientific theories, for example, included in the scenario of the present invention. In one embodiment, a bipolar instrument utilizing a five point Lichert scale is used to complete the validation.

In one embodiment, a special password protected web site to facilitate the completion of the survey questionnaire is established. Follow-up interviews are conducted, focusing on validating areas of knowledge domain expert agreement and illuminating reasons for disagreement among respondents. This method is designed for repeatability with different populations of knowledge domain experts. The methodology also allows for expansion using different conceptual frames of reference and additional scientific theories.

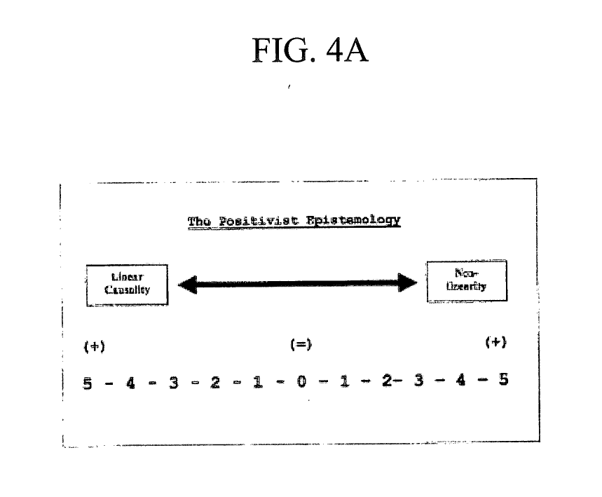

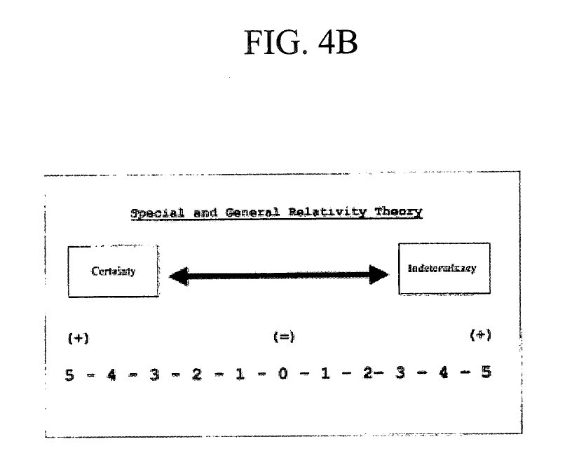

The knowledge domain experts are selected for participation in this feature of the present invention are selected, for example, because they have a direct understanding of the conceptual frames used for developing one or more of the scientific theories under study. For example, llya Prigogine as the author of dissipative structure theory has a direct understanding of the conceptual frames of reference he used to develop his own theory. Charles Perrow as the author of normal accident theory has a direct understanding of the conceptual frames of reference he develop his theory. Stephen Hawkings, as the world's used to premiere physicist, has a deep understanding of both relativity and probability theory. In similar fashion, James Gleick is a renowned expert on complexity theory. E. O. Wilson as the author of consilience theory has a direct understanding of the conceptual frames of reference he used to develop his theory. Thus, on feature of the study methodology of the present invention involves the comparison of survey responses by each of these different individuals. The responses of principals responsible for developing (or most knowledgeable about) their own theory (or knowledge domain) are compared with the responses of other participants in the study to determine degrees of agreement or disagreement. For each of the three epistemologies and seven scientific theories evaluated, for example, each respondent is asked to indicate the degree to which each of the ten cognitive frames of conceptual reference is reflected in the associated epistemology or theory. For example, respondents are asked to indicate the degree to which the concept of linear causality or its opposing frame of non-linearity is reflected in the positivist epistemology. A bipolar instrument utilizing a Lichert scale is used, such as is shown in FIGS. 4A and 4B. By moving their computer cursor along the scale, respondents are able to select the degree to which they believe the concept of linear causality or non-linearity underpins the positivist epistemology.

In FIG. 4A, for example, by selecting the number -5-, for example, to the far left under the header “Linear Causality,” the respondent is able to indicate their opinion that the positivist epistemology relies exclusively on the concept of linear causality versus non-linear causality. Choosing a number between -4- to -1- to the left side of the scale under the header “Linear Causality,” would indicate a progressively lesser degree of reliance on the concept of linear causality as the conceptual frame underpinning the positivist epistemology. In like fashion, by selecting the number -5- to the far right under the header “Non-linearity,” the respondent would indicate their opinion that the positivist epistemology relies exclusively on the concept of non-linearity versus linear causality. Choosing a number between -4- to -1- to the right side of the scale under the header “Non-linearity,” would indicate a progressively lesser degree of reliance on the concept of non-linearity as the conceptual frame underpinning the positivist epistemology. By selecting the number -0- the respondent would indicate their opinion that the positivist epistemology relies equally on both the concept of linear causality and non-linearity as conceptual frames underpinning the positivist epistemology.

In similar fashion, respondents are asked to what degree each of the ten conceptual frames of linear causality and non-linearity, reductionism and holism, certainty and indeterminacy, reversibility and irreversibility and induction and deduction underpin the seven theories. For example, as depicted in FIG. 4B, respondents are asked to what degree Newton's conceptual frame of certainty of measurement and the opposing conceptual frame of indeterminacy underpins Einstein's special and general relativity theory.

By selecting the number -5- to the far left under the header “Certainty” in FIG. 4B, the respondent indicates their opinion that the positivist epistemology relies exclusively on the concept of certainty of measurement versus indeterminacy. Choosing a number between -4- to -1- to the left side of the scale under the header “Certainty,” would indicate a progressively lesser degree of reliance on the concept of certainty of measurement as the conceptual frame underpinning the positivist epistemology. In like fashion, by selecting the number -5- to the far right under the header “Indeterminacy,” the respondent would indicate their opinion that the positivist epistemology relies exclusively on the concept of indeterminacy versus certainty of measurement. Choosing a number between -4- to -1- to the right side of the scale under the header “Indeterminacy,” would indicate a progressively lesser degree of reliance on the concept of indeterminacy as the conceptual frame underpinning the positivist epistemology. By selecting the number -0- the respondent would indicate their opinion that the positivist epistemology relies equally on both the concept of certainty of measurement and indeterminacy as conceptual frames underpinning the positivist epistemology.

An embodiment of the present invention provides for a secure password protected web site. The five knowledge domain experts, for example, participating in this study are requested by way of introductory letter and follow-up telephone call to use the web site to complete the survey questionnaire, obtain background information, and access the results of the survey instrument. In an embodiment of the present invention, the results of the survey instrument are subjected to statistical analysis to determine degrees of agreement and disagreement among the five knowledge domain expert respondents.

In an embodiment of the present invention, follow-up interviews with each of the five participating expert are conducted. Follow-up interviews focus on validating areas of knowledge domain expert agreement and illuminating areas and reasons for disagreement. This method is designed for repeatability with different populations of knowledge domain experts. The methodology also allows for expansion using different conceptual frames of reference and additional scientific theories. The results are shared with five knowledge domain experts participating in the survey.

It is possible that differences of opinion among knowledge domain experts will arise. Thus, the method provides for attempts to achieve consensus by knowledge domain experts on the definitions of key concepts and their applications in the epistemologies and theories selected for analysis. In some cases, achieving consensus on key terms or the degree of their applicability to the epistemologies and scientific theories may not be possible.

It is also possible that the epistemological logic block appearing as FIGS. 3A and 3B may change based on, for example, the inputs of the knowledge domain experts participating in the survey. It is possible that no new pattern set (i.e., unique combination of the ten conceptual frames of reference) will emerge to support a new epistemology. Should this situation arise, the analysis of the present invention serves to support the validity of one or more of the existing epistemologies under study. In either case, the results of the survey questionnaire and one-on-one interviews are carefully studied to gain insights into specific areas of disagreement and the individual epistemological frames of reference of each of the participating experts. The epistemological logic block appearing as FIGS. 3A and 3B compares and contrasts ten conceptual frames of reference and seven scientific theories. Other frames of conceptual reference and additional scientific theories exist. However, the methodology allows for expansion using different conceptual frames of reference and additional scientific theories. One feature of the method of the present invention is the identification of new areas of research.

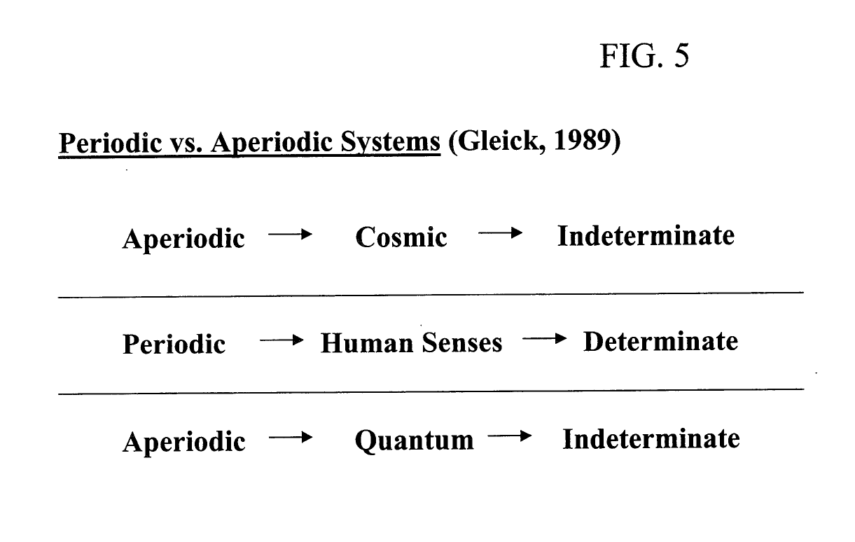

FIG. 5 illustrates aspects of periodic versus aperiodic systems.

It is believed that human problem solving is guided by the periodic perception of systems behavior (Gleick; Miller), often including the following: 1) use of stochastic statistical methods (i.e., certainty of measurement arising from Newtonian mechanics) (Gleick; Miller); 2) use of human reliability theory and process engineering to identify system weaknesses and “build-in” redundancies to preclude the occurrence of adverse events (Sagan; Perrow); 3) placement of emphasis on the quantitative aspects of equipment performance and potential failure versus qualitative social processes (Helm; Perrow); 4) consideration that accidents are often blamed on human operator error rather than the policies or processes that guide human operator actions (Helm; Perrow); and 5) consideration that these factors give rise to a “play-to-win” mind set directed at “building-in” redundant systems to preclude the occurrence of adverse events (Sagan; Helm; Perrow), but the reality is that major catastrophes continue to happen anyway (Perrow).

Pattern sets that reflect the “acceptance” or “rejection” of these conceptual frames of reference for each of the three epistemologies and seven scientific theories are identified based on the study of the scholarly literature. The epistemological pattern sets are compared and contrasted with the scientific theory pattern sets to determine whether any of the pattern sets match. Then, the pattern sets for each of the seven scientific theories are compared and contrasted with one another to identify matches. The scientific theory pattern sets that do not match any epistemological pattern set(s) are grouped and frame a unique epistemological structure. The resulting epistemological structure is unique because it reflects new combinations of the ten conceptual frames of reference not found in the positivist, logical positivist or post positivist epistemologies. This resulting epistemological structure is called apriori optionality. A practical method for applying apriori optionality to increase understanding of complex naturally occurring systems and improve the management of complex events and situations will now be described in greater.

Comparison and contrast of these analyses reveal a recurring scientific pattern set that is different from the three reigning epistemological pattern sets. The emergence of a different pattern set forms the basis for a new epistemological construct, apriori optionality. The scientific implications of apriori optionality include the following: 1) rules of linearity breakdown at upper and lower thresholds of human “observability”; 2) complex systems cannot be fully understood by reductionist methods; 3) Newtonian “clockworks” perception of reality reflects only a microcosm of existence; 4) different behaviors emerge when systems move from periodic to aperiodic states; 5) while exact pre-determination of future events does not appear possible, the identification of potential “event paths” is possible; 6) there is a need to shift away from a “play to win” mindset that attempts to preclude all adverse events to focus on those specific events that can result in catastrophes; and 7) a structured and practical method for considering potential “event paths” and their extended order effects before adverse events happen in the real world can help to prevent catastrophes.

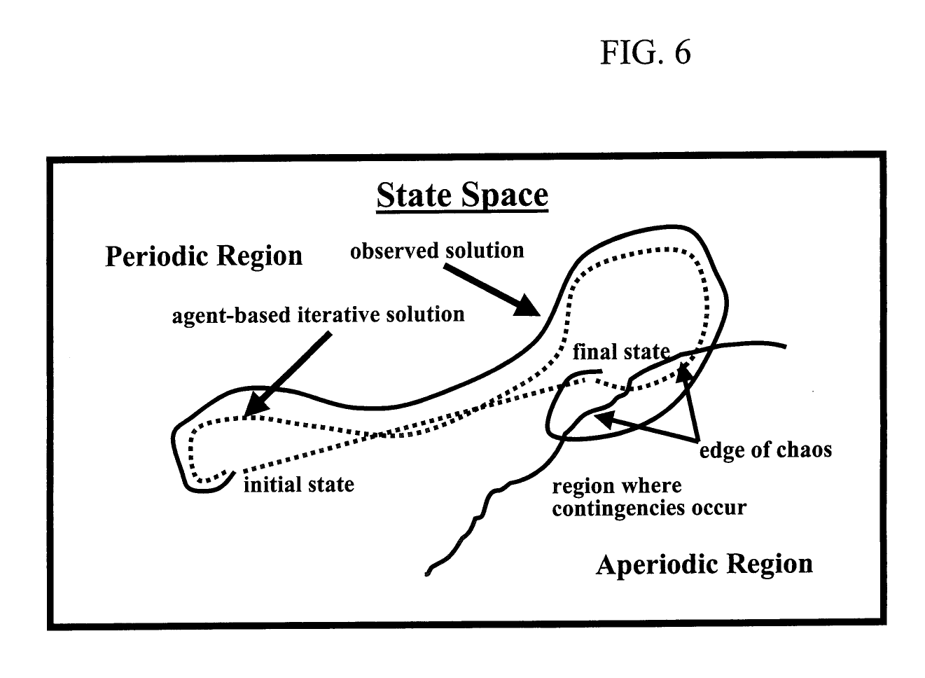

FIG. 6 shows a representative diagram of a state space having periodic and aperiodic regions, with observed and agent-based iterative solutions shown, in accordance with embodiments of the present invention.

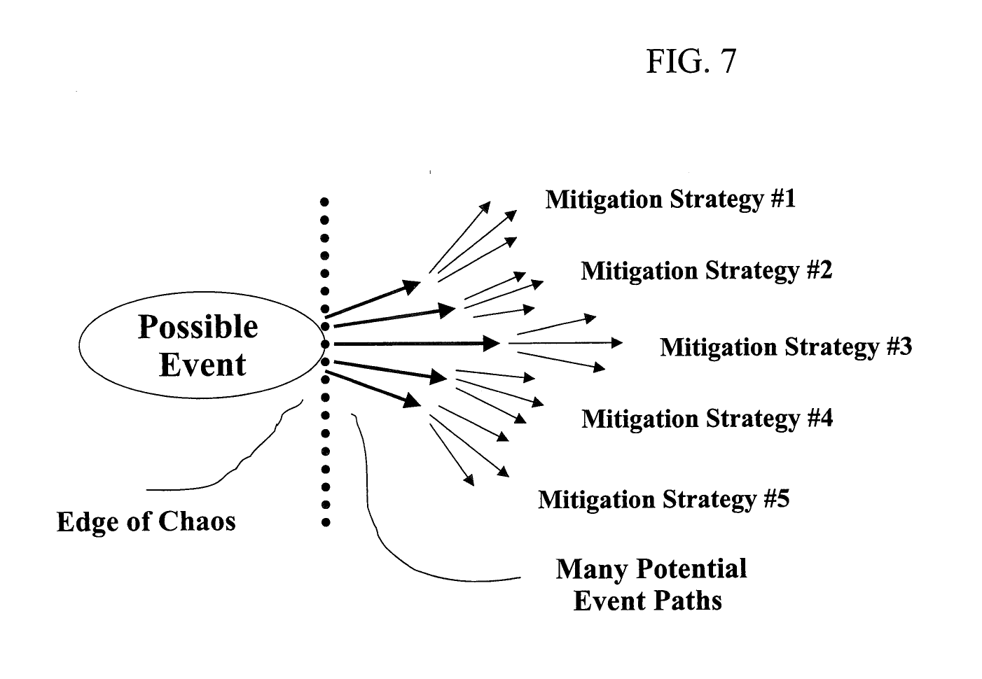

FIG. 7 contains a representative diagram of possible event outcomes and mitigation strategies for an example event, in accordance with an embodiment of the present invention.

A number of critical human factors and man-machine interface considerations are at issue with embodiments of the present invention, including the following: 1) humans will continue to rely on Newtonian “clockworks” perception of reality; 2) a challenge exists for “bringing the right information, at the right time, in the right form” to support quality decision making; 3) varying human decision and team interaction styles based on individual cognitive make-up is potentially beneficial; and 4) there is a need for integrating the qualitative and quantitative aspects of decision options to achieve consensus.

To address the identified critical human factors and man-machine Interface challenges, the present invention includes consideration or use of the following: 1) a computer-based “intelligent system” to administer on-line cognitive assessment batteries to all participants in immersions in accordance with the present invention; and 2) consideration of each participant's decision, learning and team interaction style via administration of an extensive one-on-one feedback session; 3) use of immersive environment facilitators in acquiring and generating participant knowledge and achieving consensus; 4) use of one-on-one feedback sessions designed to acquaint participants with other types of decision styles, individual preferences in team interactions and the consensus team decision model of the present invention; and 5) use of visualization tools (e.g., models, simulations and other technology support) used during immersions in accordance with the present invention are tailored to the cognitive decision, learning and team interaction style of participants.

In embodiments of the present invention, results of assessments are used to accomplish the following: a) assure diversity of decision styles; b) match information delivery to individual decision and learning styles; and c) develop additional knowledge acquisition and generation tools.

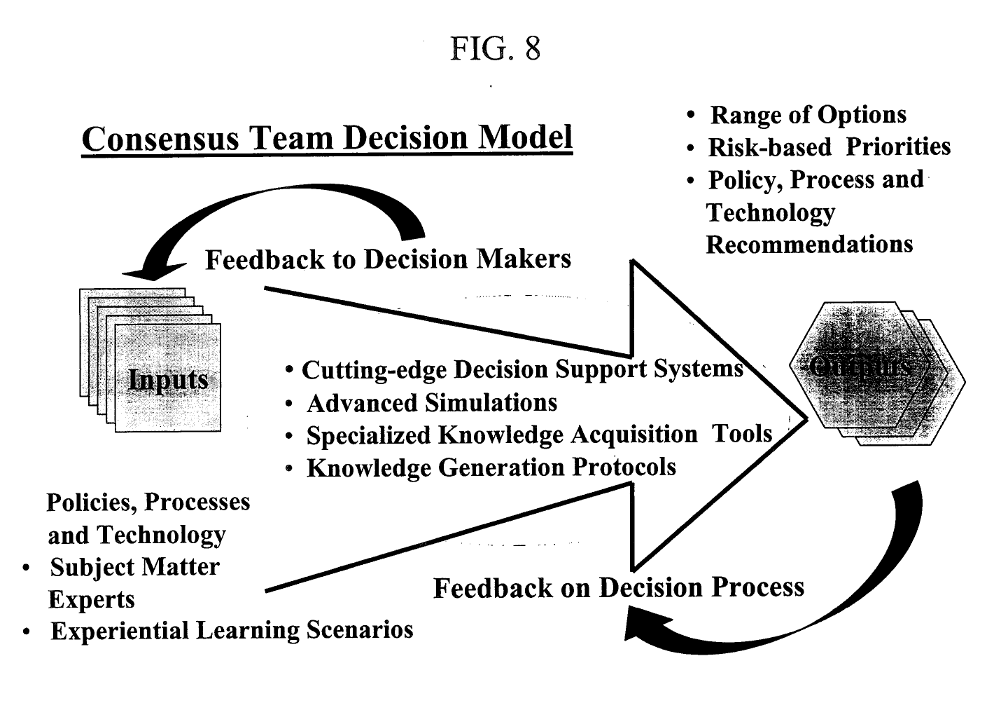

FIG. 8 shows a representative diagram of various features of a consensus team decision model, in accordance with an embodiment of the present invention.

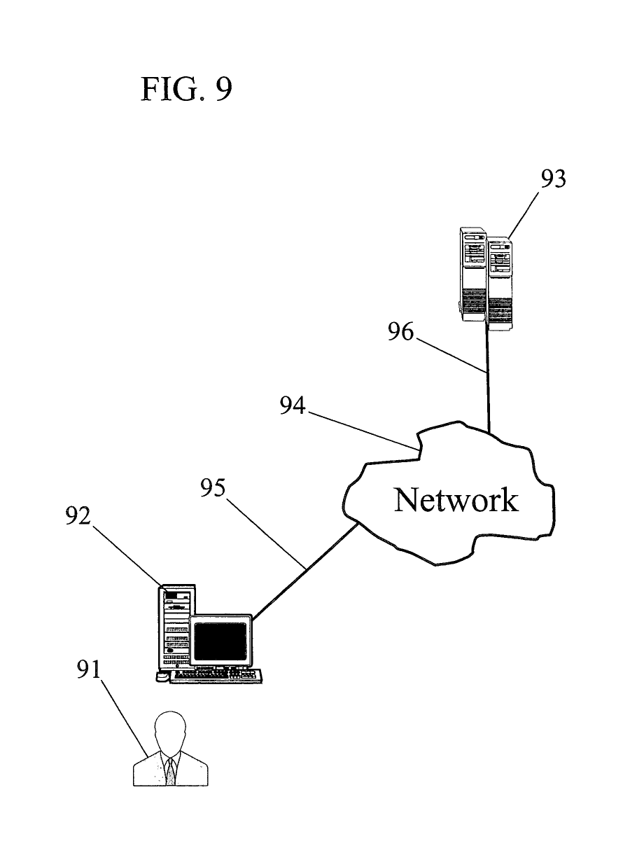

FIG. 9 shows the various system components used in an embodiment of the present invention. As shown in FIG. 9, in an embodiment of the present invention, data for use in the system is, for example, obtained by a user 91 via a terminal 92, such as a personal computer (PC), minicomputer, mainframe computer, microcomputer, telephonic device, or wireless device, such as a hand-held wireless device coupled to a server 93, such as a PC, minicomputer, mainframe computer, microcomputer, or other device having a processor and a repository for data or connection to a repository for data, via a network 94, such as the Internet or an intranet, and couplings 95, 96. The couplings 95, 96 include, for example, wired, wireless, or fiberoptic links. In another embodiment, the method and system of the present invention operate in a stand-alone environment, such as on a single terminal.

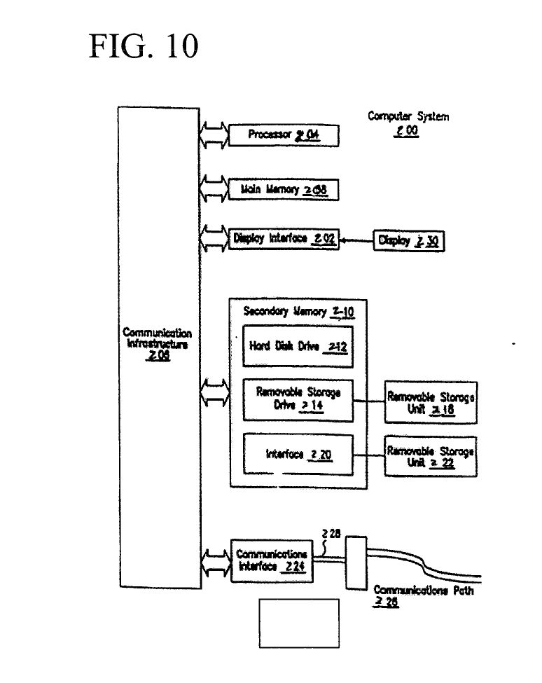

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 10.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

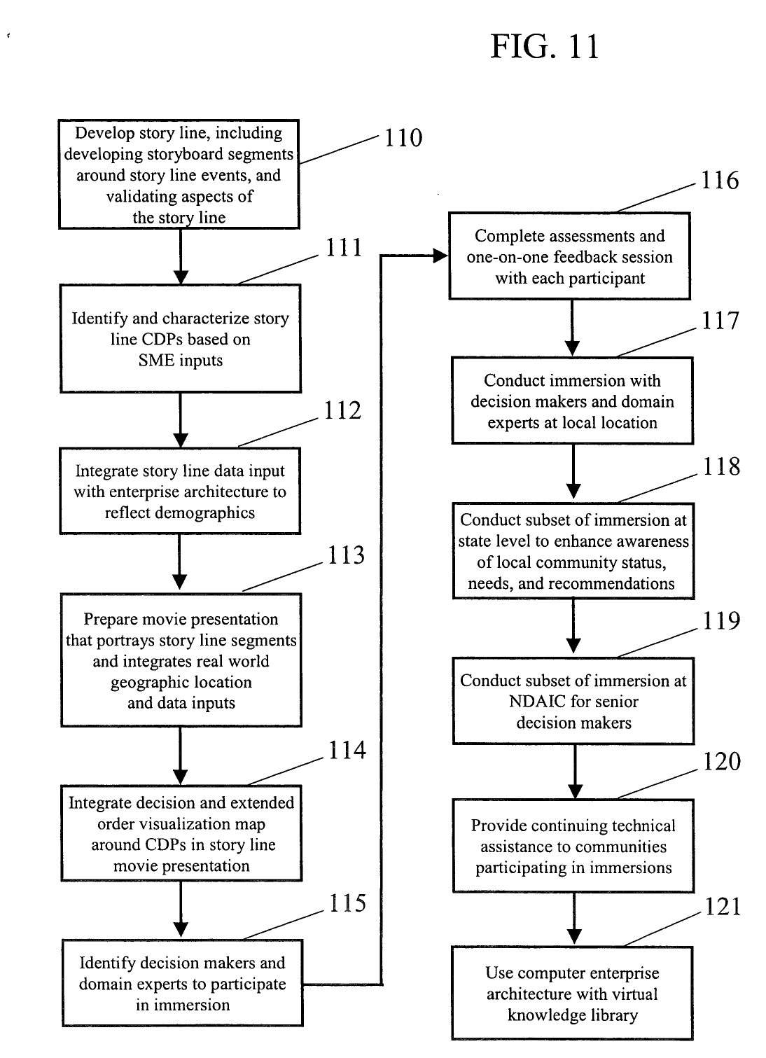

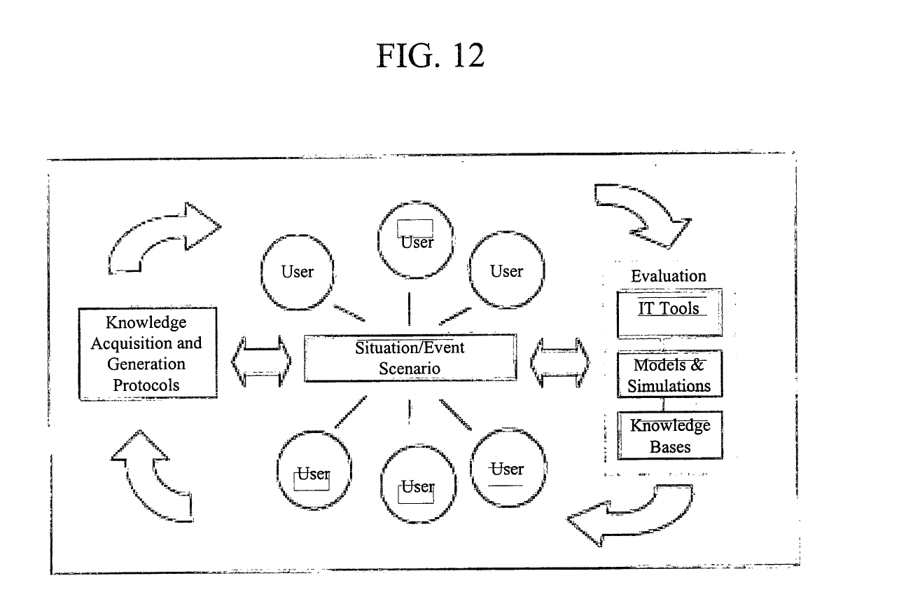

Details regarding the process methodology of one embodiment of the present invention will now be discussed in conjunction with a description of FIG. 11.

As shown in FIG. 11, a story line is developed 110. In one embodiment, the story line is derived either analogously or metaphorically using subject matter expertise (SME) and historical precedent. The derivation includes, for example, selecting a geographic location, scanning the strategic environment for information to support the story line (e.g., potential targets), or determining response resources, policies, past incidents, etc., of relevance to the scenario. Other portions of the story line development include developing storyboard segments around story line events and validating qualitative and quantitative aspects of the story line.

Another event in the methodology of the present invention involves identifying and characterizing story line CDP's based on SME inputs 111. In an embodiment of the present invention, this event includes determining story line CDP's, using commercial software capability to “map” examples of potential decision paths around each CDP, and, for each potential decision path “mapping” examples of potential extended order effects.

In an embodiment of the present invention, real world story line data inputs are integrated with computer enterprise architecture to reflect demographics of selected geographical location, policy, process and other factors 112. In one embodiment, these functions include the following: 1) interacting with immersive environment participants at local, state and federal levels to prepare them for immersion, and populating story line databases that drive computer enterprise architecture and visualization tools; and 2) otherwise enabling local/regional community as required.

Another function in the methodology of one embodiment of the present invention involves preparing a movie presentation that portrays story line segments and integrates real world geographic location and data inputs 113.

As shown in FIG. 11, decision and extended order visualization “maps” are integrated around CDP's in story line movie presentation 114. Decision makers and domain experts are identified to participate in immersion 115. Assessments and one-on-one feedback sessions are completed with each participant 116.

Immersion with decision makers and domain experts at local/regional geographic locations are conducted 117. In one embodiment, such immersion includes the following: 1) “start” and “stop” methodologies around each CDP are used; 2) acquisition and generation of new knowledge around each example CDP and newly identified CDP's are facilitated; 3) example decision paths are validated around each CDP using special visualization software, additional paths are generated, and consensus is achieved regarding priorities; 4) example extended order effects are validated around each CDP using special visualization software, additional effects are generated, and consensus is achieved regarding priorities; 5) decision paths and associated extended order effects are dynamically archived by computer enterprise architecture to create a virtual knowledge library; 6) after all CDP's have been addressed, a consolidated visualization of all story line CDP's and associated decision paths, including extended order effects, is presented to immersion participants; 7) immersion participant knowledge is acquired regarding potential mitigation strategies to prevent adverse extended order effects for each CDP; 8) CDP's are collectively considered to identify single or collective mitigation strategies with the highest payoff, and policy, process, and technology solutions are considered; and 9) this information is dynamically archived and included as part of virtual knowledge library.

A subset of the methodology that involving immersion at the state level to enhance awareness of local community status, needs, and recommendations is conducted 118. A subset of immersion at the National Decision Assessment Immersion Center (NDAIC) for senior Administration, Interagency, and Congressional Decision Makers is conducted 119.

Continuing technical assistance is provided to communities that agree to participate in immersions in accordance with the present invention 120. This help can include the following: 1) assisting in running additional exercises using enabling immersion capabilities; and 2) assisting local communities in maintaining and updating immersion databases and other enabling immersion technologies.

The enterprise architecture, for example, housed on the computer or other processing device, is used with virtual knowledge library to perform several functions 121. These functions include, for example, the following: 1) continuously sharing via a secure web site, lessons learned and recommendations arising from immersions; 2) continuously running virtually generated scenarios using computer architecture to “stress” systems based on local community database updates and changing threat conditions; 3) using the results of these virtual scenarios to create new immersion story lines; and 4) establishing an “analogous event” library of virtual events that can be immediately accessed by decision makers during real world emergencies.

Research Center

In one embodiment of the present invention, a research center, such as a National Decision Assessment Immersion Center, is established to leverage human factors research, cutting edge developments in information technology, and advances in computational modeling and simulation in ways that will enhance understanding of complex systems and the group decision processes essential to effectively managing and harnessing the potential of complex events and situations. The National Decision Assessment Immersion Center of this embodiment serves as a national resource for governments at all levels, the private sector, and universities, through which these entities are able to come together to consider a range of complex events and situations.

In one embodiment of the present invention, the National Decision Assessment Immersion Center (also referred to interchangeably herein as the NDAIC) integrates advances in modeling, simulation, and information technology, in combination with specially tailored consensus team and other group decision process techniques to capture the knowledge of the world's best multidisciplinary experts. The National Decision Assessment Immersion Center uses advanced simulations aids in developing new methods and techniques that allow for the application of this knowledge to support the a priori development and testing of policy options, processes, and procedures across a range of simulated complex events and situations. The National Decision Assessment Immersion Center of this embodiment seeks the participation of all levels of government, non-government organizations, industry, academia, and the international community, where appropriate, in implementing the program.

The focus of the present invention is the increased understanding of complex situations and events in two complimentary areas of activity. First, the National Decision Assessment Immersion Center uses hypothetical scenarios that simulate on an a priori basis a range of complex events and situations that can adversely affect both the near and long-term national and international interests of the United States. A new generation of specially tailored knowledge acquisition and generation protocols assist subject matter experts with identifying possible consequences and alternative courses of action to prevent and resolve complex events and situations that may adversely impact the interests of the United States, for example, before these events actually occur. Such events and situations include, for example, the terrorist use of weapons of mass destruction, attacks against the critical infrastructures of the nation, and conflicts in areas of regional interest to the United States.

Second, the National Decision Assessment Immersion Center uses the methods and techniques described herein to simulate a range of complex events that hold the promise of potential benefit to the near and long-term national and international interests of the United States. The purpose of these simulations is to identify opportunities, alternatives, policy options, and processes that can assist both government and private sector decision makers with maximizing the benefits of their actions in ways that support the near and long-term national and international interests of the United States. Inherent in these activities is the use of a priori simulations to identify and more effectively manage both the actuarial and the socio-political factors that “drive” policy actions.

Examples of just a few of the types of complex events and situations included in this category are the development of regional socio-cultural investment roadmaps to promote prosperity and stability, more robust proliferation-resistant commercial nuclear fuel cycles and fossil and alternative energy supply and distribution systems, and supporting government and private sector technology and research investment roadmaps.

In one embodiment, subject matter experts from federal agencies, state and local governments, industry, academia, non-government organizations, and the international community participate in the development of decision assessment scenarios and participate in the conduct of simulations. The National Decision Assessment Immersion Center utilizes, where appropriate, simulations provided by other research universities, the nation's complex of federally funded research and development centers, the national laboratories and others to support these activities.

The NDAIC of this embodiment therefore provides a unique new resource for better understanding, mitigating, preventing, and devising more effective ways to cope with complex situations and events that can become threats to national security, such as terrorist use of weapons of mass destruction, international regional conflicts, asymmetric warfare threats, attacks on critical infrastructure or facilities, agro-terrorism, and cyber-terrorism.

The NDAIC also uses the methods and techniques of the present invention to simulate a range of complex events that hold the promise of potential benefit to the near and long-term national and international interests. The purpose of these simulations is to identify opportunities, alternatives, policy options, and processes that can assist both government and private sector decision makers with maximizing the benefits of their actions in ways that support the near and long-term national and international interests.

In one embodiment, the NDAIC utilizes the following: 1) new computational modeling and simulation capabilities of research universities, the nation's complex of federally funded research and development centers, the national laboratories and others; 2) state-of-the-art data mining, information gathering, analysis, and interpretation technologies through the resources of the private sector and government organizations; 3) advanced decision support systems, including “deciding how to decide” consensus decision techniques, decision-tree processes, and other methodologies developed by major research institutions; 4) leading-edge communications and distance-learning technologies for critical-issue conferencing, data transfer, information sharing, situational awareness enhancement, scheduled learning sessions on complex situation and event management, and a substantial education component for delivery both online and onsite; 5) combined resources of a consortium of major research universities, federal laboratories and research institutions, public and private research, development and applied technology organizations; and 6) direct interaction with federal agencies, state and local governments, nongovernmental organizations, private entities, and the international community.

The NDAIC process, in an embodiment of the present invention, begins with the development of possible scenarios of complex situations and events that in some way may threaten or present opportunities for national security, such as those mentioned herein. These scenarios are as realistic as possible, built on models and simulations derived from massive informational databases put together by university research centers, national laboratories, or others, and supported by the most extensive data-mining, information gathering and analysis technologies available.

Experts in all areas related to the particular issues of the scenario are brought together, along with policy-makers at all levels, including legislative and administration officials, program managers, first responders, and appropriate local, state, and federal research, health, safety, law enforcement authorities, and other institutional resources. Various scenario play-outs are able to afford participants the opportunity to test a broad array of policies, procedures, coordination plans, and specific responses to a variety of situational developments.

The NDAIC process of this embodiment allows tracking and detailed analysis as the scenario situations mature and simulated events progress, affords assessment of the effectiveness of responses and ameliorative actions, provides direct feedback on the consequences of specific actions, policies, and procedures, and offers a computer- or other processor-supported system that “learns” as it progresses through multiple play-outs of scenario information, providing a sound basis for policy improvement. The education and information distribution components of the present invention assure dissemination to those who need it most.

FIG. 12 is a notional diagram of a decision assessment environment for exploring the validity and integration of policies among different organizations. Different organizations are depicted as “users,” which vary depending on the type of assessment (i.e., hypothetical scenario) being conducted. Teams or individuals represent “organizations.” The “situation/event scenario” block represents the hypothetical or mock situation with which participants interact, in order to explore the validity and integration of policies. Scenarios are designed, for example, to “immerse” participants. Analogical processes and the techniques that have been tested at National Defense University are used to enhance the “believability” of scenarios and to benchmark the performance of participants.

The block identified as “IT Tools, Simulations and Knowledge Bases” refers to an array of cutting edge digital tools currently available or under development to assist users within decision assessment environments. The decision assessment environment includes a wide array of state-of-the-art decision tools, including Approximate Reasoning (AR), T-squared, and data mining. Developing knowledge bases requires the input and participation of many agencies and organizations at the federal, state, and local levels, for example. To facilitate participation and integration of these agencies, support for interface development, as well as development and improvement of new and existing tools, is required.

In embodiments of the present invention, NDAIC thus offers a new approach to dealing with potential threats and opportunities relating to national security—one that is proactive rather than reactive—an approach that utilizes advanced information technology and advanced computational modeling and simulation capabilities, along with an expanding core of specialized knowledge on human interaction and decision making, to provide national decision makers a unique laboratory for learning how to deal with specific simulated complex situations and events before they can turn into real-life catastrophes or disasters.

Other Factors

As globalization progresses, more and more organizations are now each other's stakeholders, constituents and customers, becoming multinational in character and increasingly interdependent. Temporary business alliances around the “knowledge-to-application” model of competition are increasing. Who decides is becoming subordinate to how things are best decided. Organizational decision processes continue to become more alternatives-based using collective multidisciplinary inputs from internal and selected external knowledge cores.

In the future, those who develop and operate decision support systems will become the de-facto leaders and powerbrokers of organizations. More expensive basic research and development is increasingly being done in consortia and other alliances. Experts postulate that in the future the collaboratory will emerge as a way to share the costs of basic research. And with all of these changes, the wisdom of leadership at all levels is quickly becoming more important than ever before in defining and preserving the values of society and the organization.

Implications of the emergence of the new age of knowledge for the strategic environment and the future of the national security in the new millennium include the following. The strategic national security environment of the 21st century is undergoing radical adjustment. The elements of national power are being reformulated as the world moves into a new era of globalization. Economic interdependencies between and among the nations of the world are becoming stronger. Advances in science and technology are taking place at near exponential rates. These and other changes in the strategic national security environment of the 21” century are resulting in a new array of non-traditional threats against each nation, including the United States and its allies. Examples of these new non-traditional threats include the proliferation of weapons of mass destruction, cyber warfare, agroterrorism and other threats arising from our increased reliance on critical infrastructure systems. In addition, the United States must maintain a strong defense against traditional military threats and the emerging post-cold war role as an international “peace keeper.”

Amidst the backdrop of this changing strategic national security environment, the nature of the organization and its modes of operation are becoming more decentralized and dependent on broadly dispersed information networks. In line with the theory of digital force multiplication, digital technology and high order computational capabilities are also becoming more important in the generation of new knowledge, the sustainment of knowledge cores, and the integration of systems that service supply and delivery networks. As modern societies evolve, infrastructure systems are becoming more complex and increasingly dependent on other systems, creating new vulnerabilities that can undermine society's achievement. More and more, modern society is becoming reliant on sophisticated computer networks to manage these complex systems' interdependencies in ways to assure that basic physiological needs are met and the safety and security of society are preserved.

For example, water is a fundamental requirement of basic survival. Without dependable supplies of water modem society could not exist. Short disruptions in local water supplies are commonplace and the consequences can usually be mitigated. However, the larger the regional area affected and the longer the supply disruption, the more serious the situation becomes. In America today, for example, the average home and business relies on either a local government water supply or a deep-water well system. Both systems, in turn, rely on electricity to run the pumps necessary to draw water from the wells. The production of electricity, in turn, generally relies on the availability of fossil or nuclear power generation facilities. These power generation facilities require fuel (and supporting supply distribution systems to deliver it) to run the turbines that generate electricity. And, more and more, the interactions between and among these individual systems are becoming increasingly reliant on computer-networked systems designed to manage the complex interdependencies.

The result is a highly complex spider web of interrelated and interdependent systems. But like a chain, these systems of systems are only as strong as their weakest link. Thus, a well-conceived attack against computer networks used to manage large interdependent systems, upon which the basic physiological needs and the safety and security of our society depend, may be both the most difficult type of attack to protect against and the type of attack that could result in the greatest adverse impact to our society.

But, other and more direct attacks are possible. For example, a well-conceived and executed attack using a biological or chemical agent to contaminate the food and water supplies over a large population region could also have grave impact. Such an attack could have serious unanticipated consequences because of other types of complex systems interdependencies. For example, the same medical, police and public service systems relied upon to treat victims, maintain public order in times of crisis, and maintain other aspects of the public health and safety, may be degraded as their personnel ranks become depleted by a tainted food and water supply. These types of highly interdependent systems of systems vulnerabilities (i.e., “tightly coupled systems”) can allow wide ranging systems failures.

Thus, non-traditional threat events, such as computer warfare, attacks against our critical infrastructures, or the illicit use of a weapon of mass destruction, are inherently very complex because of these tightly coupled systems interdependencies. These events are so complicated because of the speed with which they can evolve and the magnitudes of the consequences that can result as impacted systems adversely affect other systems. For instance, a well-placed attack on a single critical substation of an electrical power grid could result in an electrical power surge. This power surge could blow out transformers at other critical substations, which in turn could create new power surges that blow out transformers at still more critical substations. All of these events can occur within a matter of seconds. This is an example of a quickly evolving chain reaction leading to a cascading system failure.

The inability of systems operators to recognize the need for corrective actions and act promptly enough to stop a fast moving series of events like this that can lead to wider and wider system failures is another example of a tightly coupled system. Even in this relatively simple example, the loss of power over a wider and wider geographic area can, in turn, have severe and unanticipated consequences on other critical systems, such as transportation, and medical and sanitation networks, which, in turn, adversely impact still other systems, causing still more failures.

These kinds of non-traditional threats to our future national security are complicated even further when it is considered that they may occur not only in a nation's homeland, but overseas, in the form of attacks against the populations of allies and friends, resulting in instability in regions of strategic importance to that country. In cases like these, attacks that focus on tightly coupled interdependent systems could result in longer term impacts that go well beyond the immediate populations affected, to include larger macro systems, such as commerce and trade.

Looking across the range of emerging non-traditional threats to, for example, U.S. national security, however, it appears that they share one very important characteristic in common—they are all highly complex. As the U.S. national security environment of the 21st century becomes more complicated, the ability of our strategic leaders to effectively discriminate between what is important and unimportant (i.e., filtering out the noise) and thus to ferret out the essential elements of information and to act quickly enough to prevent fast moving system failures—as these leaders manage complex events and situations—represents the new challenge for national security decision makers.

In addition, there are the human social process aspects of decision making and policy formulation that add an entirely new dimension to the notion of complexity and the challenge of effective problem solving. In today's complex world, it is becoming increasingly difficult to fully comprehend the underlying causal factors that promote poor decision-making. This is particularly true when highly skilled and objective decision-makers fail to comprehend the consequences of seemingly “routine” judgment calls that can erupt in catastrophic ways. Traditionally, U.S. culture has demanded that an individual be blamed when a catastrophe occurs, even in those cases where thoughtful analysis discloses that flawed policy, rather than the actions of an individual, was the major causal factor. However, there is an emerging body of knowledge suggesting that major systems failures are more frequently the result of flawed policies rather than human operator error. Some theorists postulate that flawed policies may actually shape the environment to cause reasonable people acting in reasonable ways to err catastrophically.

Traditionally, the U.S. response to catastrophe has been to conduct post-accident investigations is to determine the root cause or causes resulting in the event, and to assign accountability. By assigning accountability, an attempt is made to do two things: first, to assure that corrective measures are taken in order to prevent a recurrence of the event in the instant case; second, for deterrence—to send an unambiguous signal to those in positions of responsibility in organizations that negligence or failure to follow established safety policy or procedures can impact their individual job security. Thus, the principal focus of investigations is usually on whether or not human operators followed established policy and procedures. Sometimes, however, little attention is paid to the validity of policy itself and the effectiveness of the procedures that flow from it.

For example, Los Alamos National Laboratory undertook a study of the events surrounding the Cerro Grande fire that consumed thousands of acres of woodlands and threatened to consume the city of Los Alamos in New Mexico. The fire was intentionally set as part of a government program of “controlled burns.” The study concluded that individuals (i.e., human operators) were accountable for malfeasance when the fire burned out of control, even though these individuals followed established policy and procedures. The Los Alamos analysis also disclosed that the government policies and procedures that fire personnel were required to follow were inherently flawed. A subsequent government investigation of the causes of the Cerro Grande fire supports the Los Alamos findings and exonerates several former senior National Park Service employees.

The results of the Los Alamos study are significant for three important reasons. First, the study demonstrates the danger of assuming that a policy and the procedures that flow from the policy are effective. As the Cerro Grande fire and other disasters show, too frequently policies and procedures go untested for validity until during or after a calamity occurs. Second, the Los Alamos National Laboratory study demonstrates a propensity toward holding individuals—versus the organizations they work for—accountable, and assigning blame based on qualitative social process factors rather than focusing on unbiased quantitative analysis. Third, the study raises questions about how policy is derived within and between large organizations, and whether the process itself is valid. In the case of the Cerro Grande fire, the failure of different government organizations to effectively coordinate efforts to contain the fire because of conflicting policies was identified as a contributing causal factor. In the case of other government agencies, for example, a question arises as to how decision makers who formulate the policy can validate the process used to formulate it. In other words, there is a questions as to whether these decision makers may decide the best way to decide before they decide. Alternatively, it may be concluded that policy formulation is to be governed by a disjunctive consensus activity across limited subject matter expert domains, with no quality control and tests of merit before it is implemented.

In recent years, a new understanding of complex interactive systems has been brought to the fore. In this new understanding, social scientists are attempting to bridge the gap between the quantitative world of empirical science and the qualitative world of social process and organizations. These researchers maintain that there are bases in natural science that can be used to rationalize the unstructured aspects of human decision making and human behavior. These scientists believe that the better the complexity of nature is understood, the better extrapolation can be made to the human condition in order to learn how to more effectively manage society's organizations and institutions.

These policy and management theorists contend that Newton's clockwork view of the universe is no longer adequate to explain the growing complexity of society's organizations and institutions. They believe that nature shows us that “extended order effects” may never be able to be predicted in simple linear terms. Instead, people and organizations must learn in real time and be able to adapt quickly and continuously by adjusting to and taking advantage of changes in environments.

For example, social scientists postulate that two types of management patterns are required to sustain competitive advantage in an organization. “Ordinary” management worries about such things as today and tomorrow's short-term operations, the efficiency of the organization, the bottom line and people. “Extraordinary” management serves as an early detection and warning system that views the environment as uncertain and unpredictable—an environment that requires one to quickly adapt or die. Thus, the notion of the learning organization emerges. However, the work of these management theorists is largely based on metaphorical fancy rather than analogical rigor.

Currently, there is no widely accepted body of theory or methodology that integrates qualitative sociological and quantitative technology factors in the context of complex interdependent systems. The positivist tradition is characterized by the underpinning Newtonian belief that behaviors in the natural environment, including human behaviors, are guided by established rules of cause and effect—a linear, two dimensional, Euclidean perception of reality—and the natural order, where the whole is necessarily equal to the sum of its' parts. According to this reductionist view, the challenge for scientists is to achieve enough understanding of the natural environment at the micro levels of existence to discern the fundamental rules or principles that result in specified cause and effect outcomes (i.e., extrapolate behaviors at the macro level). But in the natural world that is known that complex systems broken apart into their separate “pieces” self-organize themselves in an infinite combination of ways to produce new systems with different characteristics. In other words, the sum of the parts never exactly equals the original whole.

In the study of complex systems, this gives rise to the concept of irreversibility. Irreversibility means that no matter how deeply complex systems are process-engineered, it is not possible to identify all of the potential ways these systems can reorganize themselves. In the context of major safety systems failures, such as the near meltdown of the Three Mile Island commercial nuclear power reactor, the Chernobyl reactor meltdown, and the Challenger space shuttle accident, this approach means that the behaviors of complex systems can never be fully understood, making it impossible to process-engineer, in a predictive manner, all possible systems redundancies necessary to prevent catastrophic systems failures. As noted earlier, this problem is only exacerbated when the unstructured aspects of human decision making is considered.

Normal accident theory posits that catastrophic failures are inevitable as systems grow more complex. This result occurs because the redundancies or combination of redundancies introduced by humans to prevent system failures only serve to create additional complexity. According to this view, more complexity begets more opportunity for accidents.

Other scientific research supports the move toward the development of an integrated approach that considers both qualitative social process and quantitative technical factors, to increase understanding of complex interdependent systems. Social scientists typically believe that scientific advances are leading to breakthrough discoveries that are yielding new knowledge about the soft sciences and the human decision process.

Use of Scenarios

One embodiment of the present invention harnesses consideration of these factors by focusing on the use of scenarios for developing policies or for training individual decision makers to enhance “believability” and also to enhance the trainers' ability to empirically analyze the performance of exercise participants. For example, consistent with this approach, the well documented history of the Cuban Missile Crisis of 1962 was used to identify the technical and social process factors applied by John and Robert Kennedy as they managed the situation. By studying the historical record, fourteen key technical and social process factors that led to the successful resolution of the crisis were identified. Analogical process was used to extrapolate and imbed these technical and social process factors into a scenario that used the backdrop of a current real world event with potential implications for U.S. national security. How exercise participants addressed each of the fourteen factors was analyzed and used to benchmark their performance in the exercise.

By using a real world event currently taking place in the strategic environment as the backdrop for an exemplary updated scenario (i.e., the return of the Panama Canal to Panama) conducted consistent with the present invention, the “believability” of the exercise was greatly enhanced. At the time of the event in the scenario, Hutchinson-Whampoa, Inc., the huge Hong Kong based shipping magnate, had just been granted long-term leases by the Panamanian government to operate the Port of Cristobal, which controls the Atlantic access route to the Canal, and to operate the Port of Balboa, which controls the Pacific access route. However, instead of Russian intermediate range ballistic missiles being surreptitiously introduced into Cuba, the Panama Canal scenario was crafted to have the People's Republic of China surreptitiously introduce Dong Feng-21 intermediate range nuclear missiles into the Port of Cristobal. Using this analogical thinking process to extrapolate, other aspects of the Panama Canal scenario were crafted to mirror the same type of technical and social process challenges posed during the actual Cuban missile crisis. This methodology was applied to replicate many of the same challenges that U.S. leaders faced in 1962 (e.g., violation of the Monroe Doctrine, the credibility of intelligence information, how to properly apply military force) in the context of a current and real world event, in a way that could be empirically analyzed to benchmark the actions taken by exercise participants as they worked to resolve the hypothetical crisis.

The activities are unique for several important reasons. At the very heart of the process is a better understanding of and ability to manage, complex events and situations. In developing the scenarios, for example, it may be useful to analyze the gamut of events and situations that could impact national security, ranging from the terrorist use of weapons of mass destruction and cyber warfare to physical attacks against the nation's critical infrastructures to preventing and managing regional conflicts and beyond.

The scenarios are based on the premise that the common factor shared by these types of events and situations was their inherent complexity. Use of this premise, in turn, leads to a consideration of the growing body of knowledge on the subject of chaos and complexity theory. Thus, complexity theory as a methodology to assist decision makers in preventing and resolving the harmful consequences or maximizing the possible benefits arising from complex events and situations becomes a central theme.

The scenarios utilize developments in information technology to create a teaming pedagogy different in many important respects from more traditional approaches to training. At the information technology level, the scenarios of the present invention make extensive use, for example, of the Internet and the World Wide Web to provide a “hotlink” intensive approach to information gathering and synthesis. In one embodiment, dedicated server capability is used to support multimedia teaming methods with on-line reading assignments supplemented by “mouse and click” video streaming and audio feeds. This same web-based learning platform is used to provide trainees with “intelligence” information in advance of major exercises.

In embodiments of the present invention, a special “strategic learning” methodology is used to guide trainee preparation for exercises and seminar sessions. The scenario instructs trainees to “read” (read articles and other narrative information for complete understanding and recall), “scan” (quickly review a web site for general content and future reference), “explore” (familiarize themselves with the general content of a selected web site and links to other web sites), and “watch” and “listen” (watch video streams and listen to audio feeds) prior to exercises. Web sites are selected to promote a multidisciplinary understanding of complex issues and approaches to problem solving and to hone trainee ability to discriminate between essential and non-essential information. Multimedia, in these embodiments, is thus used, among other reasons, to promote a more “active” trainee-to-computer interface and the more effective accumulation of basic knowledge prior to exercises and seminar sessions.

One aspect of the present invention is the structure of the scenarios, which integrates both technical policy and social process knowledge and the use of analogical thinking to empirically benchmark the performance of exercise participants. In devising scenarios, the outside in/big think paradigm is adopted. As the first step in this paradigm, generic areas of broad technical policy knowledge and social process knowledge are identified. For purposes of developing scenarios, technical policy knowledge includes an understanding of military and civilian agency responsibilities, the national security policy process, and the role of key decision makers and federal emergency response plans in managing highly complex situations and events. Social process knowledge includes the types of group decision process skills that are essential in the management of any complex situation that involves a diverse group of decision makers who may frequently have competing interests. The second step includes scanng the strategic environment to build a library of real world facts, situations and events (e.g., actual web sites, newspaper and magazine articles, radio and television broadcasts, videotapes of congressional hearings) that could be used to form a strategic backdrop for a scenario designed to test the generic areas of technical and social process knowledge identified in step one. A well-documented historical example of a national security event is then identified.

For instance, one scenario is designed to test trainees' technical and social process knowledge, as this knowledge pertains to the civil-military coordination of a complex contingency operation outside of the continental United States. As touched upon previously, in the exemplary scenario, the United States was about to transfer ownership of the Panama Canal to Panama. On Capitol Hill those who feared the long-term national security implications of the transfer were debating the wisdom of giving up the Panama Canal. These concerns were exacerbated when Hutchinson-Whampoa, Inc., the giant Communist Chinese shipping magnate, obtained long-term leases to two former U.S. bases of operation at the Port of Cristobal (controlling the Atlantic access way to the Canal) and Balboa (controlling the Pacific access way to the Canal). Based on these real world events, analogical process was used to extrapolate potential parallels with the 1962 Cuban missile crisis—an example of perhaps the best documented case describing how President John F. Kennedy managed a highly complex situation at both a technical policy, as well as a social process, knowledge level.

It was through this process that the idea of developing a scenario supported by the real world transfer of the Panama Canal and the imaginary introduction of Chinese Dong Feng 21 intermediate range ballistic nuclear missiles into the Port of Cristobal resulted. Using a combination of real world events and well-documented history, many of the key technical policy and social process challenges faced by President Kennedy in 1962 but within the context of a current issue—the transfer of the Panama Canal—were replicated (G. Allison, et al., Essence of Decision: Explaining the Cuban Missile Crisis (1999), which is incorporated herein by reference).

The use of this methodology for devising the Panama Canal scenario is significant for two reasons. First, the scenario is highly believable to trainees because of their knowledge and access to real world background information off of the World Wide Web and from other sources pertaining to the transfer of the Panama Canal.

The design of the present invention integrates, as seamlessly as possible, this type of real world information into scenarios. This high “believability” factor does much to increase trainee engagement in the learning process. It also helps to recreate the high levels of stress and conflict that decision makers face in managing complex high consequence situations in the real world. Second, by paying careful attention to parallels between the Panama Canal scenario and the 1962 Cuban Missile Crisis, as well as by using analogical thinking, specific benchmarks based on documented historical decision outcomes are developed in accordance with the present invention to gauge trainee performance.

Other benchmarks include, for example, the videotaping of exercises and trainer review of videotapes with trainees, which are used to identify areas of technical policy and social process knowledge strengths and weaknesses. Cognitive maps of trainee exercise teams showing areas and levels of interaction among key actors to define and prioritize issues and manage the resolution of a situation are also developed and used to gauge student performance.

In other exercises in accordance with the present invention, including National Defense University's major end of year Crisis Decision Exercise, trainees have used, for example, advanced modeling and simulation technology, such as that developed by Los Alamos National Laboratory, to help them manage complex situations. For example, in one scenario, a major bio-terrorist attack using anthrax was mounted against a major city in the United States. By combining overhead imagery to produce a grid map of the city with special atmospheric detection capability, demographic and meteorological data and plume-modeling technology (i.e., atmospheric dispersal of toxic clouds), a simulation tool was developed that could model areas and amounts of airborne contamination. Trainees are able to run the simulation off of laptop computers during exercises in the classroom. Using the tool, trainees are able to simulate areas of contamination, determine areas of lethal and non-lethal dose rites and estimate fatalities. In one embodiment, information to support the exercises is also available on-line via a special library of hot-linked World Wide Web Internet sites.

Definitions

Positivist epistemology. The positivist epistemology denies the validity of metaphysical speculations and the anthropomorphic perception of an all-knowing god. Positivists believe that there exists an objective reality independent of the observer and that the experience of the five human senses is the only thing that defines the reality of existence. Newtonian mechanics are perceived as a ruling principle and the certainty of measurement applies. The positivist epistemology focuses on the study of facts and experimentation as the way to perfect human knowledge. Abstractions or general theories or ideas are nothing more than collective judgments. Judgments are the mere colligation of facts. Rationality is articulated using inductive methods. To the positivist, all human knowledge can be reduced to sense experience and empirical analysis (i.e., quantitative analysis).

Logical positivism. Logical positivism asserts that only statements about empirical observations have any meaning thus assuring that all metaphysical statements are meaningless (i.e., “nonsense”). Logical positivists believe that there exists an objective reality independent of the observer. Newtonian mechanics are perceived as a ruling principle and the certainty of measurement applies. The logical positivist epistemology asserts that the meaning of a statement is its verification—in other words one can understand a statement only if one knows what kind of observations can verify it. This approach is known as the “verification principle.” Logical positivism assumes that all science rests on a foundation of facts. Once enough facts are collected and analyzed, generalizations can be extracted, enabling the scientist to predict, given some set of circumstances at T1, some fact that will still hold true at TZ. If the prediction is true, then the hypothesis, principle, or theory must also be true.

Post positivism. Post positivism asserts that there is a reality independent of ability to think about reality that can be studied by science. Post positivists assert that all observations are fallible and all theory is subject to revision. They contend that all that is observed is affected by observation. In this sense, Newtonian mechanics with their certainty of measurement do not apply. Thus, multiple measures and observations are core to the advancement of knowledge (i.e., triangulation). Post positivists believe that constant scrutiny of research leads to the evolutionary creation of the “best” knowledge. Under this scheme, only the best theories survive, leading to the natural selection theory of knowledge. In this context, quantitative analysis and empirical proofs do not prove or disprove hypotheses, principles or theories—they only temporarily validate the usefulness of a given hypothesis, principle, or theory. Thus, hypotheses, principles and theories are only temporary.

Special and general relativity theory. In 1915, Albert Einstein published his theory on general relativity. In special relativity theory, Einstein posits a ruling principle that distance and time are not absolute and depend on the motion of the observer. In general relativity theory, Einstein posits a ruling principle that that gravity pulling in one direction is equivalent to acceleration in the opposite direction. This is known as the equivalence principle. Einstein, like Newton before him, believed in a reality independent of the observer. He also believed, like Schrodinger, that universal principles exist to explain nature. In special relativity theory, Einstein used bold intuition to perceive space in three dimensions. Einstein's perception required the use of non-Euclidean geometry for expression. When combined, the special and general theories of relativity paint a new picture of reality (i.e., Einsteinian three-dimensional space, which is outside the bounds of the five human senses)—a reality that can only be imagined and understood via imagination and intellect.

Probability theory. In 1927, Werner Heisenberg postulated that precise measurements of sub atomic particles are impossible because of the interference (disturbances to the environments in which they are moving—i.e., effects on momentum) created by the methods used to measure them. In his Principle of Indeterminacy, Heisenberg asserts that the path of an electron can only be determined within specified bounds using stochastic statistical methods. Heisenburg abandoned the precept of Newtonian mechanics by postulating that the certainty of measurement does not exist at the sub-atomic level. He went one step further to proclaim that there is no reality independent of the observer, and that nothing can be precisely measured because the act of observation itself affects the entity we are attempting to measure. This notion, according to Heisenburg, is expressed at the subatomic level by the belief that the event path of an electron does not come into existence until after it is observed by a human being.

Dissipative structure theory. In 1977, llya Prigoine won the Nobel Prize for developing the theory of dissipative structures. Prigogine postulated that complex thermodynamic systems absorb energy to self organize at higher equilibrium states or lose energy to move to lower equilibrium states or disintegrate. Prigogine asserts that naturally occurring systems are capable of organizing and reorganizing themselves in an infinite number of ways to form new and more complex systems. This gives rise to Prigogine's belief that naturally occurring systems are irreversible (i.e., they can never be exactly replicated) and raises a question about the utility of reductionism as a conceptual frame for the understanding of complex systems.

Complexity theory. In his book, Chaos: Making a New Science, James Gleick asserts that naturally occurring systems reach levels of complex interaction where the normal rules of linearity no longer apply. Complexity theory posits that even simply formulated systems with few variables can display highly complex behavior that is unpredictable and unforeseeable. Slight differences in one variable can have profound effects on the outcome of a whole system. This is referred to as sensitive dependence on initial conditions (1987).

Normal accident theory. In his book, Normal Accidents, Charles Perrow asserts that when operating systems reach a certain threshold of complexity, accidents become inevitable. Perrow postulates, in normal accident theory, that social process factors are major contributors to breakdowns of complex safety systems. He theorizes that accidents are inevitable as systems become more complex because of the difficulty inherent in effectively integrating the human qualitative aspects of complex systems (e.g., policies, processes, and procedures) with the non-human quantitative aspects of complex systems (e.g., technical safety system design, technical specifications of operating equipment) (1982).

Consilience theory. In his book, Consilience: The Unity of Knowledge, E. O. Wilson posits that our increased understanding of science at the bio-molecular level is leading to new revelations about the nature of complex systems including human thought and consciousness. Wilson contends that this new knowledge is leading to the convergence of the hard and the soft sciences to produce what he believes is an emerging “unity of knowledge” (1999). This means that universal principles or, at the least, common denominators that explain natural behaviors that cross the boundaries between life and the lifeless universe from which it arose, must exist.

The notion of linear causality assumes that, with sufficient study, direct cause and effect relationships can be discerned to explain all phenomena. From this, universal principles to explain all natural phenomena can be determined. Systems are seen as reversible and linear. The opposing conceptual frame is nonlinearity. Nonlinearity posits that direct cause and effect relationships may not exist. From this conceptual frame, systems are perceived as irreversible.

Reductionism asserts that, with sufficient study, the individual parts of any system can be isolated and analyzed to determine their relationship(s) with other parts of the system (or systems). Systems can be dissected and reassembled to produce identical systems. Systems are seen as linear and reversible. The opposing conceptual frame is holism. Holism asserts that complex systems can be best understood using deduction to identify patterns or simplicities. These patterns or simplicities provide important insights about the functioning of a complex system.

Certainty asserts the validity of Newtonian mechanics and the notion that if one is aware of an object's momentum and speed, and all of the forces acting on the object, one can precisely determine the object's location. The opposing conceptual frame is indeterminacy. Indeterminacy asserts that no universal principle exists to predict any exact future state because exact measurements cannot be obtained. All future states are subject to the rules of probability. Probabilities can only be determined by the application of statistical methods.

Reversibility asserts that the parts of any system in the same state space, if reassembled exactly the same way as they are disassembled, will produce the identical system. The opposing conceptual frame is irreversibility. Irreversibility asserts that all natural systems are capable of organizing and reorganizing themselves in an infinite variety of ways. The sum of the parts of any system that reassembles itself will never be exactly equal to the system from which it evolved.

Induction asserts that understanding systems at the micro levels of existence reveals certain universal principles that guide systems behaviors at the macro level. The conceptual frame of induction gives rise to the notions of linearity and reductionism as the best way to understand complex systems. The opposing conceptual frame is deduction. Deduction asserts that the best way to understand a complex system is to consider it in a holistic fashion to identify patterns or simplicities that can reveal universal principals to explain system behaviors.

Example embodiments of the present invention have now been described in accordance with the above advantages. It will be appreciated that these examples are merely illustrative of the invention. Many variations and modifications will be apparent to those skilled in the art.

1. A method for providing analysis information for a decision, the method comprising:
developing a story line;
identifying at least one critical decision point within the story line;
characterizing each of the at least one critical decision point;
developing knowledge about each of the at least one critical decision point;
identifying each of the at least one critical decision point of relevance to the decision; and
providing the knowledge corresponding to each identified critical decision point.

2. The method of claim 1, wherein developing a story line includes:
developing storyboard segments.

3. The method of claim 2, wherein the storyboard segments are developed around story line events.

4. The method of claim 2, further comprising:
validating aspects of the story line.

5. The method of claim 1, wherein the story line is developed using subject matter expertise.

6. The method of claim 1, wherein the story line is developed using historical precedent.

7. The method of claim 1, wherein the story line is developed using at least one selected from a group consisting of selecting a geographic location, scanning strategic environment, determining response resources, determining policies, and determining past incidents.

8. The method of claim 1, wherein each of the at least one critical decision point is identified using subject matter expertise.

9. The method of claim 1, wherein characterizing each of the at least one critical decision point includes:
using commercial software to map at least one potential decision path.

10. The method of claim 1, wherein characterizing each of the at least one critical decision point further includes:
for each of the at least one potential decision path, mapping potential extended order effects.

11. The method of claim 1, further comprising:
integrating the story line with computer enterprise architecture.

12. The method of claim 1, wherein the story line includes a plurality of story line segments, the method further comprising:
preparing a movie presentation that portrays at least one of the plurality of story line segments.

13. The method of claim 1, further comprising:
integrating extended order visualization maps around each of the at least one decision point.

14. The method of claim 1, wherein developing knowledge about each of the at least one critical decision point includes:
identifying at least one decision maker.

15. The method of claim 14, wherein developing knowledge about each of the at least one critical decision point includes:
identifying at least one domain expert.

16. The method of claim 15, further comprising:
assessing each of the at least one decision maker and each of the at least one domain expert.

17. A method for providing assistance for a decision, the method comprising:
developing a generic scenario analogous to the decision;
developing an automated enterprise architecture;
integrating the developed generic scenario and the developed automated enterprise architecture;
identifying at least one decision option for the decision;
prioritizing each of the at least one decision option; and
identifying at least one mitigating strategy for each of the at least one decision option.

18. The method of claim 17, wherein the generic scenario is developed based on science and expert input.

19. The method of claim 17, further comprising:
identifying an extended order effect for each of the at least one decision option.

20. The method of claim 17, further comprising:
creating an analogous event library based on the identified at least one decision option and the identified at least one mitigating strategy.

21. A system for providing assistance for a decision, the system comprising:
means for developing a generic scenario analogous to the decision;
means for developing an automated enterprise architecture;
means for integrating the developed generic scenario and the developed automated enterprise architecture;
means for identifying at least one decision option for the decision;
means for prioritizing each of the at least one decision option; and
means for identifying at least one mitigating strategy for each of the at least one decision option.

22. A system for providing assistance for a decision, the system comprising:
a processor; and
a repository accessible by the processor;
wherein a generic scenario analogous to the decision is developed;
wherein an automated enterprise architecture is developed via the processor;
wherein the developed generic scenario and the developed automated enterprise architecture is integrated;
wherein at least one decision option for the decision is identified;
wherein each of the at least one decision option is prioritized; and
wherein at least one mitigating strategy for each of the at least one decision option is identified.

23. A method for validating an epistemological logic block, the method comprising:
identifying at least one epistemology and at least one scientific theory;
determining a degree of applicability of a plurality of cognitive frames for each of the at least one epistemology and each of the at least one scientific theory using a bipolar instrument; and
producing a output for the plurality of cognitive frames compared to the one epistemology and the at least one scientific theory.

24. The method of claim 23, wherein the bipolar instrument is a Lichert scale.

25. The method of claim 23, wherein the output comprises a chart.
